(19) United States
(12) Patent Application Publication
(10) Pub. No.: US 2025/0362068 A1
(43) Pub. Date: Nov. 27, 2025

(54) SYSTEMS AND METHODS FOR CONTROLLING A CHILLER

(71) Applicant: Tyco Fire & Security GmbH, Neuhausen am Rheinfall (CH)

(72) Inventors: William Leslie Kopko, Jacobus, PA (US); Justin Patrick Kauffman, York, PA (US); Douglas A. Kester, York, PA (US); Omer Sarfraz, York, PA (US)

(21) Appl. No.: 18/872,247

(22) PCT Filed: Jun. 8, 2023
(86) PCT No.: PCT/US2023/024861

§ 371 Date: Dec. 5, 2024

Related U.S. Application Data
(60) Provisional application No. 63/350,312, filed on Jun. 8, 2022.

(51) Int. Cl. F25B 49/02; F25B 25/00

(52) U.S. Cl. CPC F25B 49/02; F25B 25/005; F25B 2500/05

(57) ABSTRACT

A heating, ventilation, air conditioning, and refrigeration (HVAC&R) system configured to operate in a plurality of cooling modes includes a mechanical cooling system configured to place a working fluid in a heat exchange relationship with a cooling fluid, a free cooling system configured to place the cooling fluid in a second heat exchange relationship with an ambient air flow, and a controller comprising processing circuitry and a memory, wherein the memory comprises instructions that, when executed by the processing circuitry, are configured to cause the processing circuitry to transition operation of the HVAC&R system between the plurality of cooling modes based on a cooling demand of the HVAC&R system and based on an estimated power consumption of the HVAC&R system.

### CROSS-REFERENCE TO RELATED APPLICATIONS

This application claims priority from and the benefit of U.S. Provisional Application No. 63/350,312, entitled “SYSTEMS AND METHOD FOR CONTROLLING A CHILLER,” filed Jun. 8, 2022, which is herein incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof in response to exposure to different temperatures and pressures within components of the chiller system. The chiller system may include an evaporator configured to place the working fluid (e.g., the refrigerant) in a heat exchange relationship with a cooling fluid (e.g., water), such that the working fluid absorbs heat from the cooling fluid. The cooling fluid, cooled by the working fluid, may then be delivered to conditioning equipment and/or a conditioned environment serviced by the chiller system. In such applications, the cooling fluid may be directed through downstream equipment, such as air handlers, to condition other fluids, such as air in a building.

In certain chiller systems, a conditioning fluid (e.g., air, water) may additionally or alternatively be used to cool the working fluid. For instance, the chiller system may include a cooling tower (or other water or cooling fluid source) configured to provide the conditioning fluid to a condenser of the chiller system. The conditioning fluid may be cooled in the cooling tower (or other water or cooling fluid source) via ambient air, and the condenser may place the conditioning fluid from the cooling tower in a heat exchange relationship with the working fluid to transfer heat from the working fluid to the fluid. A compressor may be positioned between the condenser and the evaporator and may be operated to adjust a pressure of the working fluid and circulate the working fluid between the components of the chiller system.

In certain applications, a chiller may operate in a free cooling mode that may be activated during certain conditions, such as when ambient air temperature is relatively low (e.g., in the spring, winter, and/or fall seasons). When the ambient air temperature is relatively low, a cooling demand of the chiller system may be reduced and/or operating conditions may enable the chiller to operate at an adequate cooling capacity without utilizing the compressor. For example, because the cooling fluid have a relatively low temperature when the ambient temperature of outside air is relatively low, the chiller system may operate to cool the cooling fluid at an adequate capacity without operating the compressor. Unfortunately, it may be difficult to efficiently transition the chiller system between different operating modes.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heating, ventilation, air conditioning, and refrigeration (HVAC&R) system configured to operate in a plurality of cooling modes includes a mechanical cooling system configured to place a working fluid in a heat exchange relationship with a cooling fluid, a free cooling system configured to place the cooling fluid in a second heat exchange relationship with an ambient air flow, and a controller comprising processing circuitry and a memory, wherein the memory comprises instructions that, when executed by the processing circuitry, are configured to cause the processing circuitry to transition operation of the HVAC&R system between the plurality of cooling modes based on a cooling demand of the HVAC&R system and based on an estimated power consumption of the HVAC&R system

In another embodiment, a tangible, non-transitory, computer-readable medium, includes instructions executable by processing circuitry of a heating, ventilation, air conditioning, and refrigeration (HVAC&R) system that, when executed by the processing circuitry, cause the processing circuitry to operate a mechanical cooling system and a free cooling system in a hybrid cooling mode of the HVAC&R system, calculate an estimated total amount of cooling capacity provided by the HVAC&R system in the hybrid cooling mode, and calculate a first estimated amount of input power consumed by the mechanical cooling system and the free cooling system in the hybrid cooling mode to provide the total amount of cooling capacity. The instructions, when executed, further cause the processing circuitry to determine that operation of the free cooling system and suspended operation of the mechanical cooling system in a free cooling mode of the HVAC&R system is expected to provide the total amount of cooling capacity, calculate a second estimated amount of input power consumed by the free cooling system in the free cooling mode to provide the total amount of cooling capacity, compare the first estimated amount of input power to the second estimated amount of input power; and transition operation of the HVAC&R system from the hybrid cooling mode to the free cooling mode in response to a determination that the second estimated amount of input power is less than the first estimated amount of input power.

In another embodiment, a heating, ventilation, air conditioning, and refrigeration (HVAC&R) system, includes a mechanical cooling system configured to circulate a working fluid therethrough and to transfer heat from a cooling fluid to the working fluid, a free cooling system configured circulate the cooling fluid therethrough and to transfer heat from the cooling fluid to ambient air, and a controller. The controller is configured to operate the mechanical cooling system and suspend operation of the free cooling system in a mechanical cooling mode of the HVAC&R system, operate the free cooling system and suspend operation of the mechanical cooling system in a free cooling mode of the HVAC&R system, operate the mechanical cooling system and operate the free cooling system in a hybrid cooling mode of the HVAC&R system, and transition operation of the HVAC&R system between the mechanical cooling mode, the free cooling mode, and the hybrid cooling mode based on a cooling demand of the HVAC&R system, a first power consumption associated with operation of the mechanical cooling system, and a second power consumption associated with operation of the free cooling system.

### BRIEF DESCRIPTION OF THE DRAWINGS

Various aspects of this disclosure may be better understood upon reading the following detailed description and upon reference to the drawings in which:

FIG. 1 is a perspective view of an embodiment of a building utilizing a heating, ventilating, air conditioning, and refrigeration (HVAC&R) system in a commercial setting, in accordance with an aspect of the present disclosure;

FIG. 2 is a perspective view of an embodiment of a vapor compression system that may include a free cooling system and a mechanical cooling system, in accordance with an aspect of the present disclosure;

FIG. 3 is a schematic of an embodiment of a vapor compression system having a mechanical cooling system and a free cooling system, in accordance with an aspect of the present disclosure;

FIG. 4 is a schematic of an embodiment of a vapor compression system having a mechanical cooling system and a free cooling system, in accordance with an aspect of the present disclosure;

FIG. 5 is a schematic of an embodiment of a vapor compression system having a mechanical cooling system and a free cooling system, in accordance with an aspect of the present disclosure;

FIG. 6 is a graphical representation of ambient temperature as a function of cooling load demand for various modes of operation of a vapor compression system, in accordance with an aspect of the present disclosure; and

FIG. 7 is a flow diagram of an embodiment of a method for controlling transitions between operating modes of a vapor compression system.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

Embodiments of the present disclosure relate generally to a heating, ventilating, air conditioning, and refrigeration (HVAC&R) system utilizing a vapor compression system, which may be referred to herein as a chiller or chiller system. More particularly, embodiments of the present disclosure relate to a control system (e.g., control scheme) for a chiller system that includes a free cooling system and a mechanical cooling system. As will be appreciated, a free cooling system may include a system that places a fluid (e.g., heat transfer fluid, cooling fluid) in a heat exchange relationship with ambient air. Accordingly, the free cooling system may utilize the ambient air in a surrounding environment as a cooling and/or a heating fluid. The HVAC&R system may operate utilizing the free cooling system alone (e.g., free cooling mode), the mechanical cooling system alone (e.g., mechanical cooling mode), or the free cooling system and the mechanical cooling system simultaneously (e.g., hybrid cooling mode). To determine which system(s) of the HVAC&R system to operate (e.g., an operating mode in which to operate), the HVAC&R system may include various sensors and/or other monitoring devices that measure operating conditions (e.g., speed of fans, speed of compressor, ambient air temperature, and conditioning fluid temperature) of the HVAC&R system. For example, in accordance with embodiments of the present disclosure, the determination of which system(s) to operate may depend at least on a desired cooling load demand (e.g., a desired temperature of the load) and/or an ambient air temperature (e.g., a temperature of a surrounding environment of the HVAC&R system).

As noted above, the presently disclosed chiller system (e.g., refrigeration system, vapor compression system) may be configured to operate in various operating modes (e.g., various cooling modes) based on certain conditions (e.g., environmental conditions, operating conditions) associated with the chiller system. For example, during the free cooling mode, the chiller system may circulate a cooling fluid (e.g., heat transfer fluid, water, glycol, brine) through a heat exchanger to enable heat exchange from the cooling fluid to ambient air. In the free cooling mode, fans may be operated to direct a flow of the ambient air across the heat exchanger. A compressor of the mechanical cooling system may not operate (e.g., may not be powered) during operation of the chiller system in the free cooling mode. During a mechanical cooling mode, the chiller is configured to circulate a working fluid (e.g., refrigerant) through the mechanical cooling system (e.g., the compressor, an evaporator, a condenser, and an expansion valve, among other possible components) of the chiller system. Thus, in the mechanical cooling mode, the compressor is powered to circulate the working fluid through the mechanical cooling system. The evaporator may place the working fluid and the cooling fluid (e.g., water) in a heat exchange relationship, such that the working fluid absorbs heat from the cooling fluid. The cooling fluid may be circulated between the evaporator and other equipment, such as air handling equipment in a building, in which the cooling fluid is used to cool an air flow delivered to a conditioned space. In some embodiments, an air handling unit (AHU) of the HVAC&R system may receive the cooling fluid from the chiller system and utilize the cooling fluid to cool the air flow delivered to the conditioned space. The cooling fluid may then be returned to the chiller system to be cooled again.

In certain conditions, such as during fall, winter, and/or spring seasons, the ambient air or other cooling medium may be relatively cool. The relatively cool ambient air may enable more efficient operation of the chiller system to satisfy a cooling demand. For example, in a free cooling operating mode, the chiller system may direct (e.g., via operation of fans) the ambient air across a heat exchanger of the free cooling system through which the cooling fluid is circulated in order to cool the cooling fluid. Further, the relatively cool ambient air may also be utilized to cool a working fluid of the mechanical cooling system. For example, the chiller system may direct (e.g., via operation of fans) the ambient air across a heat exchanger (e.g., a condenser) of the mechanical cooling system (e.g., different from the heat exchanger of the free cooling system) through which the working fluid is circulated in order to cool the working fluid. The working fluid may then be directed to an evaporator of the mechanical cooling system to cool the cooling fluid. Thus, in certain conditions, the ambient air may be utilized to improve operation of the chiller in the free cooling mode and the mechanical cooling mode.

During a hybrid cooling mode, the HVAC&R system may be configured to operate the mechanical cooling system and the free cooling system (e.g., simultaneously). For example, the compressor of the vapor compression system may be operated at a reduced capacity to provide a portion of a total cooling capacity to satisfy a load demand of the HVAC&R system, and one or more fans of the free cooling system may be operated to provide another portion of the total cooling capacity to satisfy the load demand of the HVAC&R system. Typically, HVAC&R systems employing a free cooling system and a mechanical cooling system are configured to operate the free cooling system at an upper capacity limit before operating the mechanical cooling system because it is generally believed that the free cooling system (e.g., one or more fans of the free cooling system) consumes less power than the mechanical cooling system (e.g., a compressor of a vapor compression cycle). For example, a free cooling system may include one or more fans that direct ambient air across a coil of a heat exchanger to cool a cooling fluid flowing through the coil. In order for the fans to operate, power is supplied to the one or more fans to drive operation of the fans to force the ambient air across the coil and enable the ambient air to absorb heat from the cooling fluid. On the other hand, in the mechanical cooling mode, the HVAC&R system consumes power via operation of the compressor of the mechanical cooling system. Thus, in the hybrid cooling mode described herein, the HVAC&R system may consume power via operation of the fans of the free cooling system and operation of the compressor of the mechanical cooling system.

In traditional systems configured to operate in multiple modes (e.g., cooling modes, mechanical cooling mode, hybrid cooling mode, free cooling mode), it may be difficult to efficiently transition between different cooling modes and/or to efficiently balance a load demand between a free cooling system and a mechanical cooling system in a hybrid operating mode. Thus, it is now recognized that improved systems and methods for controlling transition between different cooling modes of a vapor compression system are desired. In accordance with the present techniques, certain embodiments include a control system that may be utilized to more efficiently transition an HVAC&R system between cooling modes in order to increase efficiency (e.g., energy efficiency) of the HVAC&R system generally. For example, the control system may be configured to estimate energy usage values (e.g., total input power) of the HVAC&R system for different cooling modes based on current operating conditions and/or expected operating conditions. Based on the estimated energy usage values, the control system may determine whether to transition operation of the HVAC&R system to a different cooling mode (e.g., to satisfy an existing load demand on the HVAC&R system). For example, the control scheme may be configured to calculate an energy consumption level (e.g., total input power) of a current cooling mode (e.g., mechanical cooling mode, hybrid cooling mode, free cooling mode) and to calculate an expected energy consumption level of a different cooling mode (e.g., mechanical cooling mode, hybrid cooling mode, free cooling mode). Based on a comparison of the energy consumption level of the current operating mode and the expected energy consumption level of a different operating mode, the control system may determine whether to transition operation of the HVAC&R system to the different operating mode. For example, based on a determination that a different operating mode would result in increased energy efficiency (e.g., less input power utilized by the HVAC&R system to satisfy a current load demand), the control system may transition operation to the different operating mode. In this way, present embodiments enable improved operation of HVAC&R systems by increasing energy efficiency, thereby reducing costs (e.g., energy costs) associated with operation of chillers.

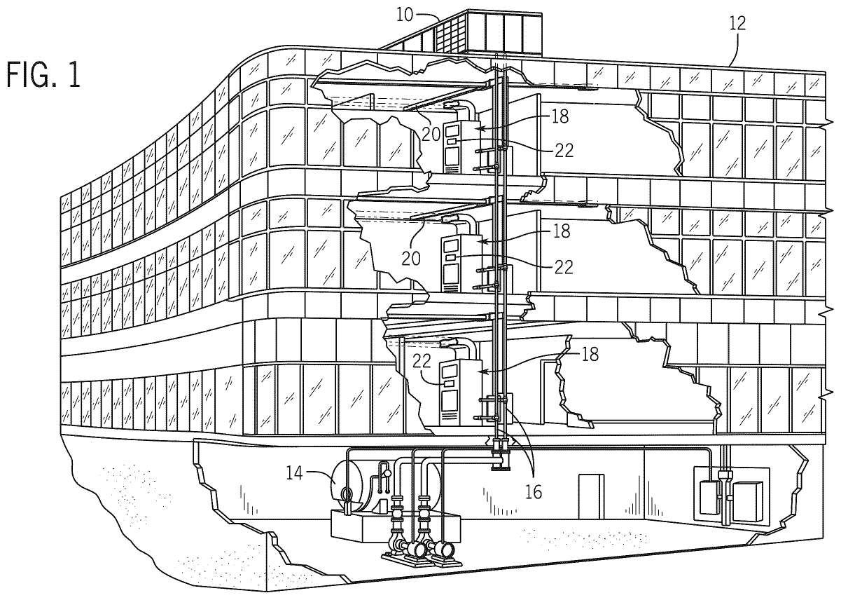

Turning now to the figures, FIG. 1 is a perspective view of an embodiment of an environment for a heating, ventilation, air conditioning, and refrigeration (HVAC&R) system 10 of a building 12 for a typical commercial setting. HVAC&R systems 10 may provide cooling to data centers, electrical devices, freezers, coolers, or other environments through vapor-compression refrigeration, absorption refrigeration, and/or thermoelectric cooling. In presently contemplated applications, however, HVAC&R systems 10 may also be used in residential, commercial, light industrial, industrial, and in any other application for heating or cooling a volume or enclosure, such as a residence, building 12, structure, and so forth. Moreover, HVAC&R systems 10 may be used in industrial applications, where appropriate, for refrigeration and heating of various fluids.

In the illustrated embodiment, the building 12 is cooled by a system that includes the HVAC&R system 10 (e.g., a chiller system, an air-cooled chiller) and a boiler 14. As shown, the HVAC&R system 10 is disposed on the roof of the building 12, and the boiler 14 is located in the basement; however, the HVAC&R system 10 and the boiler 14 may be located in other equipment rooms or areas next to the building 12. The HVAC&R system 10 is an air cooled device and/or a mechanical cooling system that implements a refrigeration cycle to cool a cooling fluid, such as water, glycol, or another heat transfer fluid. The HVAC&R system 10 is housed within a structure that may include a mechanical cooling system, a free cooling system, and associated equipment such as pumps, valves, and piping. For example, the HVAC&R system 10 may be single package rooftop unit that incorporates a free cooling system and a mechanical cooling system. The boiler 14 is a closed vessel that includes a furnace to heat a heating fluid. The cooling fluid from the HVAC&R system 10 and the heating fluid from the boiler 14 are circulated through the building 12 by conduits 16. The conduits 16 are routed to air handlers 18, located on individual floors and within sections of building 12.

The air handlers 18 are coupled to ductwork 20 that is adapted to distribute air between the air handlers 18 and may receive air from an outside intake. The air handlers 18 include heat exchangers that circulate cold cooling fluid from the HVAC&R system 10 and hot heating fluid from the boiler 14 to provide heated or cooled air. Fans within the air handlers 18 draw air across coils of the heat exchangers and direct the conditioned air to environments within the building 12, such as rooms, apartments, or offices, to maintain the environments at a designated temperature. A control device, shown as including a thermostat 22, may be used to designate the temperature of the conditioned air. The control device 22 may also be used to control the flow of air through and from the air handlers 18. Other devices may, of course, be included in the system, such as control valves that regulate the flow of cooling/heating fluid and pressure and/or temperature transducers or switches that sense the temperatures and pressures of the cooling/heating fluid, the air, and so forth. Moreover, the control devices 22 may include computer systems that are integrated with and/or separate from other building control or monitoring systems, including systems that are remote from the building 12.

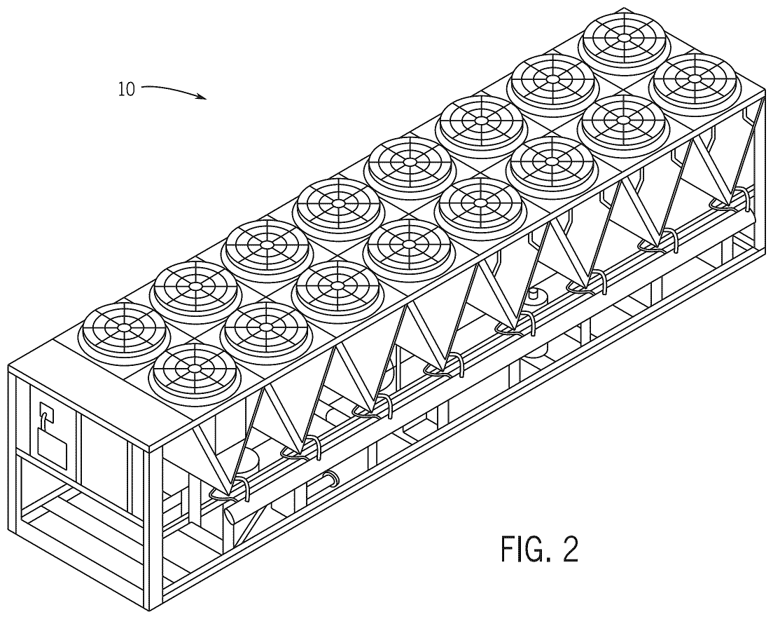

In accordance with embodiments of the present disclosure, the HVAC&R system 10 may include a mechanical cooling system and a free cooling system. For example, FIG. 2 is a perspective view of an embodiment of the HVAC&R system 10 that may include both a mechanical cooling system (e.g., a vapor-compression refrigeration cycle) and a free cooling system configured to improve efficiency of the HVAC&R system 10. The free cooling system and the mechanical cooling system may be operated alone or in combination with one another. In certain embodiments, the HVAC&R system 10 may include a control system configured to determine whether and how to operate the mechanical cooling system and/or the free cooling system based various operating parameters of the HVAC&R system 10, such as a temperature of ambient air (e.g., air in a surrounding environment of the HVAC&R system 10) and/or a cooling load demand (e.g., an amount of cooling demanded by a load). The HVAC&R system 10 may operate the mechanical cooling system alone (e.g., in a mechanical cooling mode), the free cooling system alone (e.g., in a free cooling mode), or the mechanical cooling system and the free cooling system in conjunction with one another (e.g., in a hybrid cooling mode) to meet the cooling load demand.

As discussed above, it may be desirable to limit or reduce an amount of energy input to the HVAC&R system 10 in order to improve efficiency of the HVAC&R system 10. In typical systems, a speed of a fan of a free cooling system may be increased to an upper limit or capacity before a compressor of a mechanical cooling system is activated (e.g., initialized, operated) in order to achieve a desired cooling load. However, it is now recognized that improved transitions between one or more available operating modes (e.g., free cooling mode, hybrid cooling mode, mechanical cooling mode) may enable the HVAC&R system 10 to satisfy load demands while limiting an amount of energy consumed, thereby increasing efficiency of the HVAC&R system 10. Accordingly, the present disclosure is directed to a control system of the HVAC&R system 10 configured to control transition between operating modes of the HVAC&R system 10 and to enable more efficient operation of the mechanical cooling system and free cooling system.

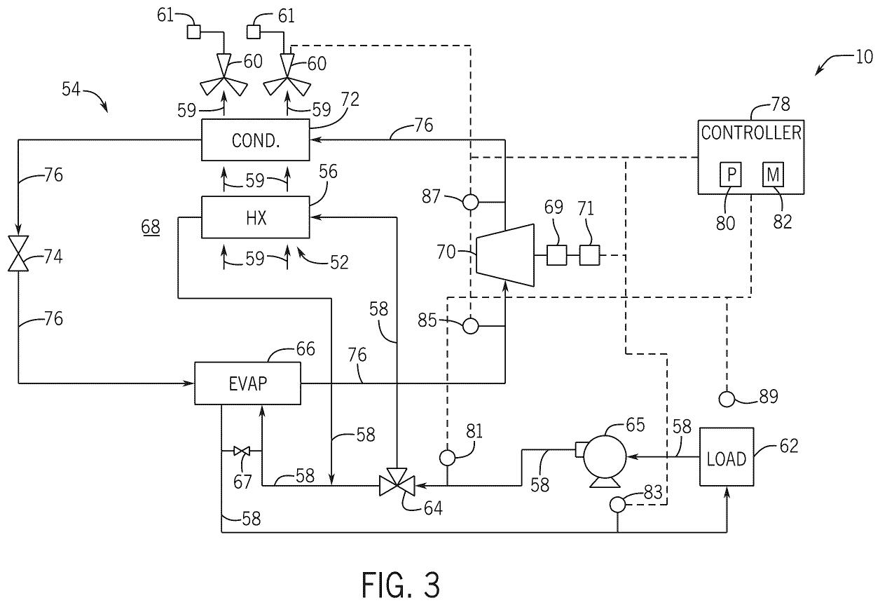

For example, FIG. 3 is a block diagram of an embodiment of the HVAC&R system 10 that may be utilized in accordance with present techniques. As shown in the illustrated embodiment, the HVAC&R system 10 includes a free cooling system 52 and a mechanical cooling system 54 (e.g., one or more vapor compression systems). The free cooling system 52 may include an air-cooled heat exchanger 56 (e.g., free cooling heat exchanger, free cooling coil) that may receive and cool a cooling fluid 58 (e.g., water, glycol, brine, heat transfer fluid). For example, the air-cooled heat exchanger 56 may be positioned along an air flow path 59 created by one or more fans 60 that direct air (e.g., ambient air) over one or more coils of the air-cooled heat exchanger 56. One or more of the fans 60 may be coupled to a variable speed drive (VSD) 61, which may receive alternating current (AC) power having a particular fixed line voltage and fixed line frequency from an AC power source and provide power having a variable voltage and frequency to a respective fan 60 coupled to the VSD 61. In this way, a speed of the one or more fans 60 may be controlled (e.g., adjusted), thereby enabling modulation of an amount of cooling capacity provided by the free cooling system 52. The air-cooled heat exchanger 56 may include round-tube plate-fin coils with internally enhanced tubes and louvered fins to improve heat transfer. When ambient air is at a relatively low temperature, the air directed across the coils of the air-cooled heat exchanger 56 may absorb heat from the cooling fluid 58, thereby decreasing a temperature of the cooling fluid 58 and increasing a temperature of the ambient air flowing across the coils of the air-cooled heat exchanger 56. In certain embodiments, the cooling fluid 58 may be received by the air-cooled heat exchanger 56 from a load 62. Therefore, the cooling fluid 58 may ultimately be re-directed toward the load 62 to lower a temperature of the load 62 (e.g., air or fluid that may be directed through a building or a machine).

However, the free cooling system 52 may not be as effective or efficient in certain operating conditions, such as when the temperature of the ambient air is relatively high. For example, an amount of heat transfer between the cooling fluid 58 and the ambient air in the air-cooled heat exchanger 56 may decrease as the temperature of ambient air increases (e.g., the ambient air may not absorb as much heat from the cooling fluid 58 when the ambient air is relatively warm). Therefore, the HVAC&R system 10 may include a valve 64 (e.g., three way valve, modulating valve, electronic controlled valve [ECV]) that controls an amount of the cooling fluid 58 that may flow toward the free cooling system 52. For example, the valve 64 may block the cooling fluid 58 from flowing directly from the load 62 toward an evaporator 66 of the mechanical cooling system 54 and simultaneously enable flow of the cooling fluid 58 through the air-cooled heat exchanger 56 when ambient air temperature is sufficiently below a temperature of the cooling fluid 58 returning from the load 62, such that free cooling supplies at least a portion of the cooling load demand. In some instances, such as during operation of the HVAC&R system 10 in a hybrid cooling mode, the cooling fluid 58 may then flow through the evaporator 66, which may further cool the cooling fluid 58.

As shown in the illustrated embodiment of FIG. 3, the valve 64 may receive the cooling fluid 58 from a pump 65 and may be selectively operated to direct a flow of the cooling fluid 58 toward the evaporator 66 (e.g., directly from the load 62), toward the air-cooled heat exchanger 56 and then toward the evaporator 66, or both. In certain embodiments, the valve 64 may be a three-way valve that includes a tee and two, two-way butterfly valves mechanically coupled to an actuator that may adjust a position of the valves (e.g., one butterfly valve opens and the other butterfly valve closes). It should be noted that, while the valve 64 is positioned upstream of the air-cooled heat exchanger 56 in the embodiment of FIG. 3 (e.g., relative to flow of the cooling fluid 58), the valve 64 may be positioned downstream of the air-cooled heat exchanger 56 in other embodiments. In still further embodiments, the valve 64 may be a modulating valve configured to simultaneously supply and control respective flows of the cooling fluid 58 to the air-cooled heat exchanger 56 and to the evaporator 66 from the load 62.

During operating conditions in which free cooling is able to provide substantially all of the cooling load demand (e.g., when the ambient air temperature is below a threshold temperature), the mechanical cooling system 54 may not operate, such that the HVAC&R system 10 operates in the free cooling mode. In the free cooling mode, the valve 64 may be controlled to direct all or substantially all of the cooling fluid 58 from the load 62 through the air-cooled heat exchanger 56. The cooling fluid 58 may then be directed to flow through the evaporator 66, in some embodiments. With operation of the mechanical cooling system 54 suspended in the free cooling mode, the cooling fluid 58 may flow through the evaporator 66 without experiencing a substantial temperature change (e.g., substantially no heat may be transferred from the cooling fluid 58 in the evaporator 66). In some embodiments, the HVAC&R system 10 may include a bypass valve 67 to enable flow of the cooling fluid 58 (or a portion of the cooling fluid 58) to bypass the evaporator 66. In certain embodiments, controlling the flow of cooling fluid 58 to bypass the evaporator 66 may substantially avoid a pressure drop experienced by the cooling fluid 58 that may otherwise be induced by flowing through the evaporator 66.

During operating conditions in which free cooling is unable to provide substantially all of the cooling load demand, the mechanical cooling system 54 may be operated (e.g., operated either alone or simultaneously with the free cooling system 52). In certain embodiments, the mechanical cooling system 54 may be a vapor compression system 68 that includes the evaporator 66, a compressor 70, a condenser 72, and/or an expansion device (e.g., expansion valve) 74, among other components. For example, the mechanical cooling system 54 may be configured to circulate a working fluid 76 (e.g., a refrigerant), which may be evaporated (e.g., vaporized) in the evaporator 66 via heat transfer with the cooling fluid 58 (e.g., the cooling fluid 58 transfers thermal energy to the working fluid 76 in the evaporator 66). Therefore, heat may be transferred from the cooling fluid 58 to the working fluid 76 within the evaporator 66, thereby decreasing a temperature of the cooling fluid 58 (e.g., either in lieu of or in addition to the free cooling system 52). In certain embodiments, the cooling fluid 58 and/or the working fluid 76 may include glycol, a mixture of glycol and water, brine, or another suitable fluid. In some embodiments, the working fluid 76 may be any suitable refrigerant, such as hydrofluorocarbon (HFC) based refrigerants, for example, R-410A, R-407, R-134a, R-1234ze, R1233zd hydrofluoro olefin (HFO), “natural” refrigerants like ammonia (NH3), R-717, carbon dioxide (CO2), R-744, or hydrocarbon-based refrigerants, or any other suitable refrigerant.

The evaporator 66 may be a brazed-plate, direct-expansion (DX) shell-and-tube heat exchanger, a flooded shell-and-tube heat exchanger, a falling film shell-and-tube heat exchanger, a hybrid falling-film and flooded heat exchanger, another type of heat exchanger, or any combination thereof. For embodiments that utilize direct-expansion (DX) evaporators, the working fluid (e.g., refrigerant) 76 may flow on a tube side of the evaporator 66, and the cooling fluid 58 may flow along one or more passes through the evaporator 66 (e.g., two, three, four or more passes). For embodiments that utilize evaporators with refrigerant on a shell-side of the evaporator 66, the cooling fluid 58 may flow through tubes within the shell of the evaporator 66 in one, two, three, or more passes.

The working fluid (e.g., refrigerant) 76 exiting the evaporator 66 may flow toward the compressor 70, which is configured to circulate the working fluid 76 through the vapor compression system 68. Additionally, the compressor 70 may increase a pressure of the working fluid 76 as the working fluid 76 circulates (e.g., cycles) through the vapor compression system 68. Increasing the pressure of the working fluid 76 may also increase the temperature of the working fluid 76, such that the temperature of the working fluid 76 exiting the compressor 70 is greater than the temperature of the working fluid 76 entering the compressor 70. Accordingly, it may be desirable to decrease the temperature of the working fluid 76 so that the working fluid 76 may ultimately absorb heat from the cooling fluid 58 in the evaporator 66. In some embodiments, the compressor 70 may be driven by a motor 69 which may be powered by a variable speed drive (VSD) 71. The VSD 71 receives alternating current (AC) power having a particular fixed line voltage and fixed line frequency from an AC power source, and provides a particular fixed line voltage and fixed line frequency to the motor 69 to drive the compressor 70.

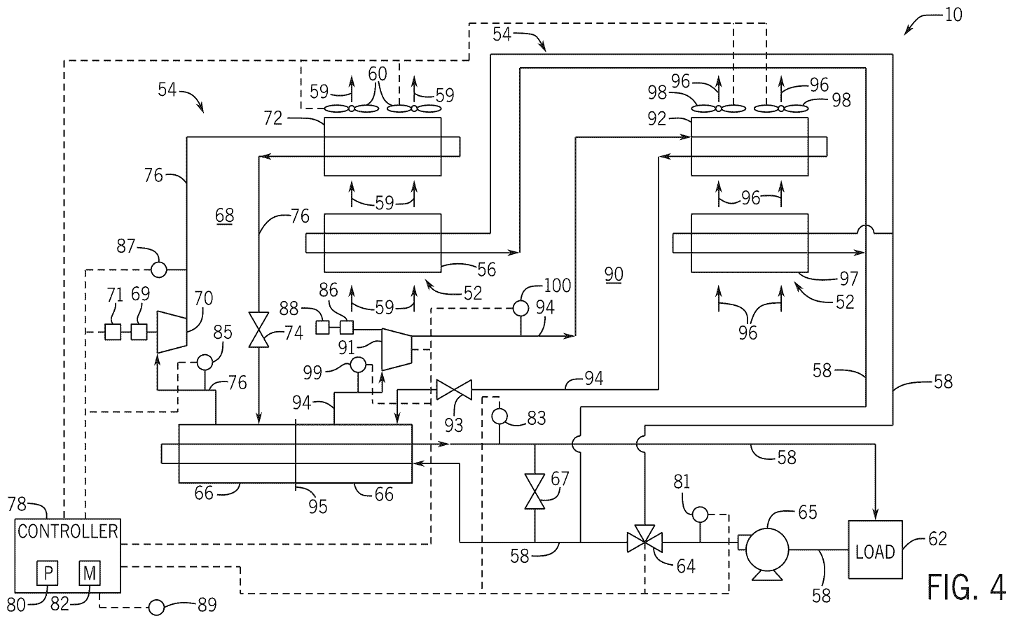

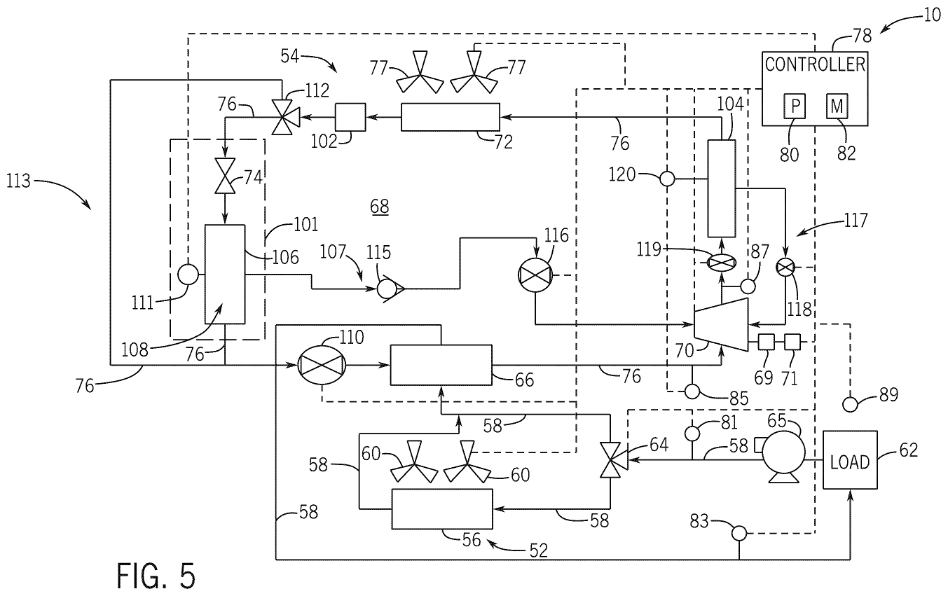

The working fluid 76 exiting the compressor 70 may flow toward the condenser 72. In certain embodiments, the condenser 72 of the mechanical cooling system 54 may be an air-cooled heat exchanger, similar to the air-cooled heat exchanger 56 of the free cooling system 52. In some embodiments, one or more sets of coils of the condenser 72 may include microchannel coils configured to circulate the working fluid 76 therethrough. In embodiments of the condenser 72 configured as an air-cooled heat exchanger, the condenser 72 may share the fans 60 with the air-cooled heat exchanger 56. In other embodiments, separate fans may direct separate air flows across the air-cooled heat exchanger 56 and the condenser 72. As shown in the illustrated embodiment of FIG. 3, the condenser 72 may be positioned downstream of the air-cooled heat exchanger 56 with respect to the air flow path 59. Thus, the ambient air may first be directed across the air-cooled heat exchanger 56 of the free cooling system 52 and may subsequently flow across the condenser 72. In this way, free cooling of the cooling fluid 58 may be improved. In other embodiments, the condenser 72 may include fans 77 separate from the fans 60 (e.g., see FIGS. 4 and 5). In still further embodiments, the condenser 72 of the mechanical cooling system 54 may be any suitable heat exchanger configured to transfer heat from the working fluid 76 to another medium (e.g., water, air). In any case, the condenser 72 is configured to decrease a temperature of the working fluid 76 and generally liquefy (e.g., condense) the working fluid 76.

In certain embodiments, the mechanical cooling system 54 may also include the expansion device 74, which may further decrease a temperature of the working fluid 76, as well as decrease the pressure of the working fluid 76. The expansion device 74 may include an expansion valve, a flash tank, an expansion coil, another device configured to decrease a pressure of the working fluid 76 (and decrease a temperature of the working fluid 76), or any combination thereof. In other embodiments, the mechanical cooling system 54 may not utilize the expansion device 74.

As discussed above, the cooling fluid 58 may decrease in temperature by flowing through the free cooling system 52 and/or the evaporator 66 of the mechanical cooling system 54. However, when a cooling load demand (e.g., a predetermined and/or desired temperature of the load 62 and/or a predetermined temperature of the cooling fluid 58 exiting the evaporator 66) exceeds a capacity of the free cooling system 52 alone, the free cooling system 52 and the mechanical cooling system 54 may be operated in conjunction with one another (e.g., simultaneously, in a hybrid cooling mode). Accordingly, the cooling fluid 58 may be directed toward the air-cooled heat exchanger 56 of the free cooling system 52, whereby the cooling fluid 58 may decrease in temperature from a first temperature to a second temperature (e.g., the second temperature is less than the first temperature). Additionally, in the hybrid cooling mode, the cooling fluid 58 may be directed toward the evaporator 66 of the mechanical cooling system 54 upon exiting the air-cooled heat exchanger 56. The cooling fluid 58 may further decrease in temperature from the second temperature to a third temperature (e.g., the third temperature is less than the second temperature, and thus, the first temperature) upon entering the evaporator 66 during operation of the HVAC&R system 10 in the hybrid cooling mode. Upon exiting the evaporator 66, the cooling fluid 58 may be directed toward the load 62, and the cooling fluid 58 may be utilized to cool the load 62.

In certain operations, a first portion of the cooling fluid 58 may be directed from the load 62 toward the air-cooled heat exchanger 56 of the free cooling system 52, while a second portion of the cooling fluid 58 may be directed from the load 62 toward the evaporator 66 of the mechanical cooling system 54 (e.g., via the valve 64). In other operations, generally all of the cooling fluid 58 may either flow through the air-cooled heat exchanger 56 before entering the evaporator 66 or may directly flow through the evaporator 66.

The HVAC&R system 10 may include a controller 78 (e.g., control system, automation controller) that may adjust a position of the valve 64, a position of the bypass valve 67, a speed of the one or more fans 60 (e.g., via the VSD 61), a speed of the one or more fans 77 (e.g., see FIG. 5), a speed of the compressor 70 (e.g., via the VSD 71), and/or any other operating parameters of the HVAC&R system 10 that may affect a temperature of the cooling fluid 58 supplied to the load 62. The controller 78 may adjust operation of the HVAC&R system 10 and components thereof based on data or feedback provided to the controller 78. Accordingly, the HVAC&R system 10 may include one or more sensors that may monitor operating conditions of the HVAC&R system 10. For example, the HVAC&R system 10 may include a return cooling fluid temperature sensor 81, a supply cooling fluid temperature sensor 83, a suction pressure and/or temperature sensor 85, a discharge pressure and/or temperature sensor 87, and/or an ambient temperature and/or pressure sensor 89. The temperature and/or pressure sensors may provide feedback to the controller 78, which may then adjust a position of the valve 64, a position of the bypass valve 67, a speed of the one or more fans 60 (e.g., via the VSD 61), a speed of the one or more fans 77 (FIG. 5), and/or a speed of the compressor 70 (e.g., via the VSD 71) based on the feedback received from the one or more sensors.

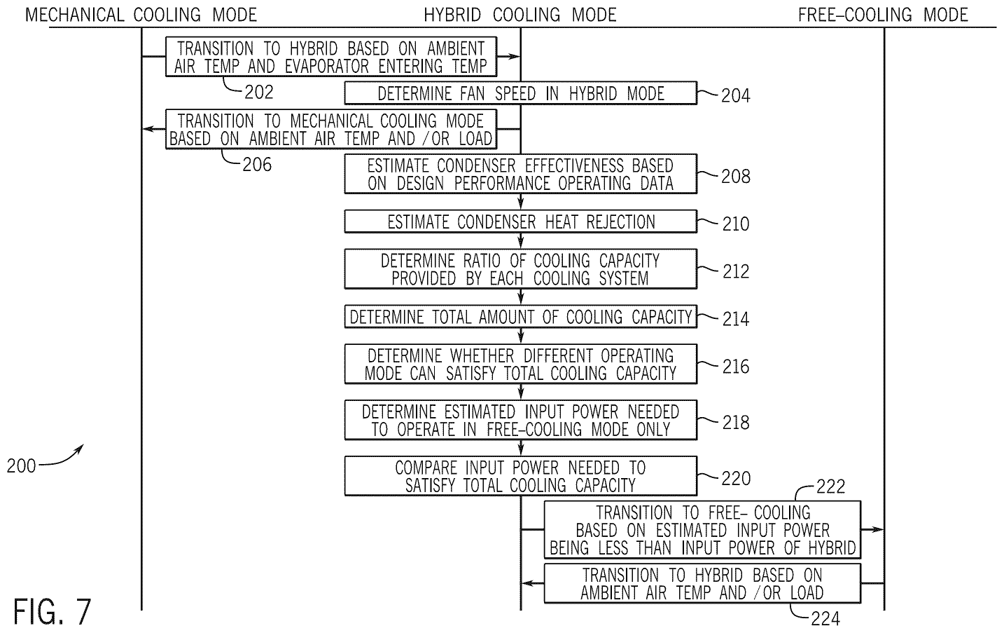

In certain embodiments, the controller 78 may include processing circuitry 80 (e.g., one or more microprocessors) and a memory 82. The processing circuitry 80 may include multiple microprocessors, one or more “general-purpose” microprocessors, one or more special-purpose microprocessors, and/or one or more application specific integrated circuits (ASICS), or some combination thereof. For example, the processing circuitry 80 may include one or more reduced instruction set (RISC) processors. The controller 78 may include non-transitory code or instructions stored on a machine-readable medium (e.g., the memory 82) that are executed by the processing circuitry 80 to implement the techniques disclosed herein. The memory 82 may include volatile memory, such as random-access memory (RAM), and/or non-volatile memory, such as read-only memory (ROM), optical drives, hard disc drives, solid-state drives, or any other non-transitory computer-readable medium storing instructions that, when executed by the processing circuitry 80, control operation of the HVAC&R system 10. Additionally, the memory 82 may store experimental data and/or other values relating to predetermined operating conditions of the HVAC&R system 10. The controller 78 may monitor and control the operation of the HVAC&R system 10, for example, by adjusting a position of the valve 64, a position of the bypass valve 67, a speed of the one or more fans 60, a speed of the one or more fans 77, and/or a speed of the compressor 70 based on the feedback received from the one or more sensors. Indeed, in accordance with present techniques, the controller 78 may be configured to control the HVAC&R system 10 to transition between one or more of the operating modes described herein. Further, the controller 78 may be configured to balance a cooling load or load demand of the HVAC&R system 10 between the free cooling system 52 and the mechanical cooling system 54. In this way, the controller 78 of the HVAC&R system 10 may be configured to perform operations that may enhance an efficiency of the HVAC&R system 10. Such operations are discussed in more detail herein with reference to FIG. 7.

FIG. 4 is a block diagram of an embodiment of the HVAC&R system 10, illustrating the mechanical cooling system 54 having the vapor compression system 68 (e.g., a first vapor compression system) and a second vapor compression system 90. The second vapor compression system 90 may include a second compressor 91, a second condenser 92, and a second expansion device 93. Additionally, the second vapor compression system 90 may be configured to direct a working fluid (e.g., refrigerant) 94 through the evaporator 66 to provide additional cooling when the cooling load demand is relatively high. The second vapor compression system 90 may be configured to operate in substantially the same manner as the vapor compression system 68 described above to provide cooled working fluid 94 to the evaporator 66, whereby the cooled working fluid 94 may absorb heat from the cooling fluid 58. In some embodiments, the working fluid 94 may be the same fluid as the working fluid 76 (e.g., water, glycol, a mixture of water and glycol, refrigerant). In other embodiments, the working fluid 94 may be different than the working fluid 76. Further, in some embodiments, the second compressor 91 may also be driven by a motor 86 coupled to a variable speed drive (VSD) 88, thereby enabling control of a speed of the second compressor 91 to modulate a cooling capacity provided by the second vapor compression system 90.

As shown in FIG. 4, the vapor compression systems 68 and 90 share the evaporator 66 (e.g., a single evaporator, a common evaporator). In other words, the evaporator 66 is a component of each of the vapor compression systems 68 and 90. The evaporator 66 may be a shell-and-tube heat exchanger with the working fluids 76 and 94 on a shell-side and the cooling fluid 58 on a tube-side of the evaporator 66. A partition 95 of the evaporator 66 may separate working fluid flow paths of the two vapor compression systems 68 and 90 through the evaporator 66. In some embodiments, the partition 95 may function as a tube sheet to support tubes within the evaporator 66. In other embodiments, DX evaporators or brazed-plate evaporators may be utilized when multiple vapor compression systems 68 and 90 are included in the HVAC&R system 10, and each of the vapor compression systems 68 and 90 incorporated in the HVAC&R system 10 may have a respective evaporator.

As shown in the illustrated embodiment of FIG. 4, the second condenser 92 may be positioned in a separate air flow path 96 from the condenser 72. In some embodiments, the free cooling system 52 may include a second air-cooled heat exchanger 97 positioned along the air flow path 96, which may share fans 98 with the second condenser 92. In the illustrated embodiment, air flow (e.g., ambient air) is directed along the air flow path 59 from the ambient environment, across the air-cooled heat exchanger 56, across the condenser 72, through the fans 60, and is then discharged from the HVAC&R system 10. Likewise, air flow (e.g., ambient air) is directed along the air flow path 96 from the ambient environment, across the second air-cooled heat exchanger 97, across the second condenser 92, through the fans 98, and is then discharged from the HVAC&R system 10. In other embodiments, the condenser 72, the second condenser 92, the air-cooled heat exchanger 56, and/or the second air-cooled heat exchanger 97 may be positioned in any suitable arrangement to meet the cooling load demand. In still further embodiments, one or more of the condenser 72, the second condenser 92, the air-cooled heat exchanger 56, and the second air-cooled heat exchanger 97 may share fans (e.g., the condenser 72, the second condenser 92, the air-cooled heat exchanger 56, and/or the second air-cooled heat exchanger 97 are positioned in the same air flow path) such that, for example, ambient air flows across the air-cooled heat exchanger 56, the second air-cooled heat exchanger 97, the condenser 72, the second condenser 92, and/or the fans 60 in a series flow configuration.

Additionally, the controller 78 may be communicatively coupled to a second suction pressure and/or temperature sensor 99 and a second discharge pressure and/or temperature sensor 100 to monitor a pressure and/or temperature of the working fluid 94 entering and exiting the second compressor 91, respectively. In some embodiments, the pressure and/or temperature of the working fluid 94 entering and exiting the second compressor 91 may enable the controller 78 to determine whether to increase and/or decrease a speed of the second compressor 91 (e.g., via VSD 88).

FIG. 5 is a block diagram of an embodiment of the HVAC&R system 10 that includes additional components that may be incorporated in the HVAC&R system 10. In particular, the HVAC&R system 10 includes an economizer 101, a filter 102, an oil separator 104 and/or additional valves that may provide enhanced control of the HVAC&R system 10 to cool the load 62 and thereby enhance the efficiency of the HVAC&R system 10. The economizer 101 is a component of the vapor compression system 68. The economizer 101 may include the expansion device 74 as well as a flash tank 106. In certain embodiments, the flash tank 106 may receive the working fluid 76 from the expansion device 74 at a relatively low pressure and low temperature. The flash tank 106 may be a vessel that is configured to rapidly lower the pressure of the working fluid 76 even further to separate vapor working fluid from liquid working fluid. Accordingly, a first portion of the working fluid 76 may vaporize (e.g., change from liquid to vapor) as a result of the rapid expansion within the flash tank 106. In some embodiments, the first portion of the working fluid 76 that vaporizes may bypass the evaporator 66 and be directed toward the compressor 70 via a bypass circuit 107. Additionally, a second portion of the working fluid 76 may remain in liquid form and may collect at a bottom 108 of the flash tank 106. In some embodiments, a valve 110 may be included downstream of the flash tank 106 and upstream of the evaporator 66, such that a flow of the second portion of working fluid 76 (e.g., from the flash tank 106 to the evaporator 66) may be adjusted based on operating parameters of the HVAC&R system 10. For example, when the condenser 72 reduces a temperature of the working fluid 76 to a level such that the first portion exiting the flash tank 106 is substantially less than the second portion, the valve 110 may be adjusted to increase the flow of the second portion of the working fluid 76 directed toward the evaporator 66 so that more working fluid 76 is evaporated in the evaporator 66 and directed toward the compressor 70.

Additionally, the flash tank 106 may include a liquid level sensor 111 that may monitor an amount of the second portion of the working fluid 76 (e.g., liquid portion) collected in the bottom 108 of the flash tank 106. The liquid level sensor 111 may be communicatively coupled to the controller 78 to provide feedback to the controller 78 regarding the amount of liquid working fluid collected in the flash tank 106. In certain embodiments, the controller 78 may be configured to perform an output, function, or command based on the feedback received from the liquid level sensor 111. For example, in certain embodiments, a three-way valve 112 may be positioned between the condenser 72 and the economizer 101. In response to a determination that the working fluid liquid level detected in the flash tank 106 reaches or exceeds a threshold level, the three-way valve 112 may be adjusted (e.g., via the controller 78) to direct the working fluid 76 toward the evaporator 66 along a bypass circuit 113, thereby bypassing the economizer 101 (e.g., the temperature of the working fluid is too low, and thus the additional cooling provided by the economizer 101 may not be desired). Additionally, in response to a determination that the working fluid liquid level detected in the flash tank 106 falls below a predetermined level, the three-way valve 112 may be adjusted (e.g., via the controller 78) to enable all or a substantial portion of the working fluid 76 to incur additional cooling in the economizer 101 by blocking flow of the working fluid 76 through the bypass circuit 113.

As shown in the illustrated embodiment of FIG. 5, the vapor compression system 68 may also include a check valve 115 disposed along the bypass circuit 107 that may block the first portion of the working fluid 76 from flowing from the compressor 70 toward the flash tank 106. Accordingly, the first portion of the working fluid 76 (e.g., vapor working fluid) may be directed from the flash tank 106 toward the compressor 70, where the pressure of the first portion of the working fluid 76 may increase. Additionally or alternatively, a valve 116 (e.g., solenoid valve, modulating valve) may be disposed along the bypass circuit 107 between the flash tank 106 and the compressor 70. The controller 78 may be communicatively coupled to the valve 116, and the controller 78 may adjust a position of the valve 116 (e.g., via an actuator configured to adjust a position of the valve 116) to control a flow of the first portion of the working fluid 76 directed to the compressor 70. It may be desirable to control the flow of the first portion of the working fluid 76 from the flash tank 106 toward the compressor 70, for example, based on a current operating speed or operating capacity of the compressor 70. In some embodiments, in response to a determination that the compressor 70 is operating near a predetermined capacity (e.g., upper threshold capacity), the controller 78 may adjust the valve 116 to decrease a flow rate of the first portion of the working fluid 76 flowing toward the compressor 70. Similarly, in response to a determination that the compressor 70 is operating generally below a predetermined or desired capacity, the controller 78 may adjust the valve 116 to increase the flow of the first portion of the working fluid 76 flowing toward the compressor 70.

Additionally, the vapor compression system 68 may include the filter 102 that may be utilized to remove contaminants from the working fluid 76. In certain embodiments, acids and/or oil may become mixed with the working fluid 76 that cycles through the vapor compression system 68. Accordingly, the filter 102 may be configured to remove contaminants from the working fluid 76 such that the working fluid 76 entering the expansion device 74, the flash tank 106, the compressor 70, and/or the evaporator 66 includes fewer contaminants.

The vapor compression system 68 may also include the oil separator 104, which may be positioned downstream of the compressor 70 and upstream of the condenser 72, for example. The oil separator 104 may be utilized to remove oil that may be entrained in the working fluid 76 flowing through the compressor 70. Accordingly, oil collected by the oil separator 104 may be returned from the oil separator 104 to the compressor 70 via a recirculation circuit 117. For example, a valve 118 may be positioned along the recirculation circuit 117 to control a flow and/or pressure of the oil returning from the oil separator 104 and flowing toward the compressor 70. The valve 118 may be communicatively coupled to the controller 78. Therefore, the amount of oil returned to the compressor 70 may be adjusted by the controller 78 (e.g., via an actuator configured to adjust a position of the valve 118). In certain embodiments, the oil separator 104 may be a flash vessel, a membrane separator, or any other device configured to separate oil from the working fluid 76.

Additionally, a valve 119 may be positioned between the compressor 70 and the oil separator 104 to control an amount of the working fluid 76 flowing toward the oil separator 104. In some cases, the oil separator 104 may include an oil level monitoring device (e.g., an oil level sensor 120) that may enable the controller 78 and/or an operator to determine an amount of oil collected in the oil separator 104. In response to a determination that the amount of oil in the oil separator 104 exceeds a predetermined threshold level, the controller 78 may adjust a position of the valve 119 to decrease a flow of the working fluid 76 toward the oil separator 104. In some embodiments, the controller 78 may also adjust a position of the valve 118 to increase the amount of oil returned to the compressor 70 from the oil separator 104. Accordingly, the level of oil in the oil separator 104 may decrease, thereby enabling more of the working fluid 76 to flow toward the oil separator 104, and thus, toward the condenser 72. While the present discussion focuses on the vapor compression system 68, it should be noted that the second vapor compression system 90 may also include an economizer, a filter, an oil separator and/or the additional valves and components discussed with reference to FIG. 5.

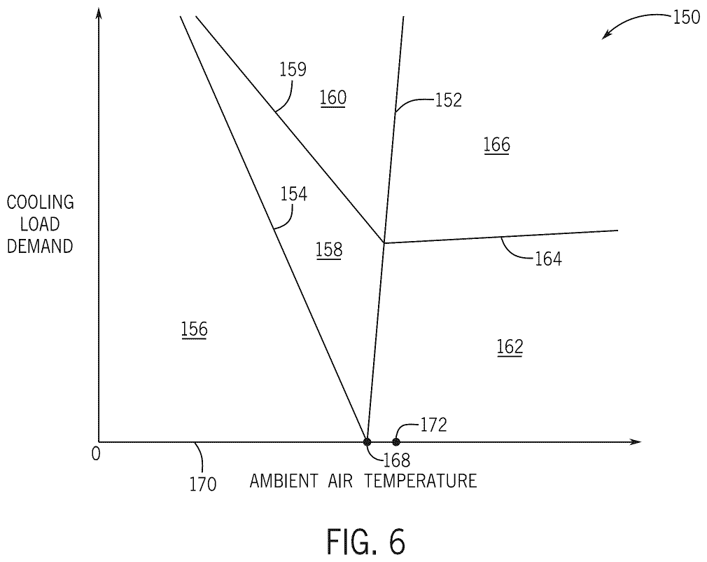

FIG. 6 is a graphical representation 150 of cooling load demand as a function of ambient air temperature in various modes of operation of the HVAC&R system 10. The graphical representation assumes a constant temperature of the cooling fluid 58 returning from the load 62 (e.g., a temperature detected by the return cooling fluid temperature sensor 81) and a constant flow rate of the cooling fluid 58. Accordingly, the graphical illustration 150 illustrates different modes in which the HVAC&R system 10 may operate based at least on the ambient air temperature and cooling load demand. It should be appreciated that the modes described below may be implemented via operation of the controller 78 described above (e.g., in response to feedback from one or more sensors received by the controller 78).

As represented in the illustrated embodiment of FIG. 6, in response to a determination that the ambient air temperature (e.g., detected by ambient temperature sensor 89) is below a first threshold temperature line 152 at a particular cooling load demand, the free cooling system 52 may be operated. In other words, the first threshold temperature line 152 may represent ambient air temperatures at which free cooling may be effective and/or efficient for absorbing heat from the cooling fluid 58 at different cooling load demands. In some applications, the first threshold temperature line 152 may be determined or established based on the return cooling fluid 58 temperature (e.g., temperature of the cooling fluid 58 returning from the load 62), the cooling load demand 62, and/or other operating parameters of the HVAC&R system 10. Further, in response to a determination that the ambient air temperature is below a second threshold temperature line 154 at a particular cooling load demand, the HVAC&R system 10 may operate in a free cooling only mode 156 (e.g., without operation of the mechanical cooling system 54). Thus, the second threshold temperature line 154 may represent ambient air temperatures at which the cooling load demand may be satisfied by the HVAC&R system 10 without utilizing the mechanical cooling system 54 and/or without operating the one or more fans 60 above a threshold speed at different cooling load demands. Thus, the ambient temperatures represented by the second threshold temperature line 154 may be less than the ambient temperatures represented by the first threshold temperature line 152.

In response to a determination that the ambient air temperature exceeds the second threshold temperature line 154 but is below the first threshold temperature line 152 for a particular cooling load demand, the controller 78 may be configured to operate the compressor 70 of the vapor compression system 68 (e.g., the mechanical cooling system 54) in a first hybrid cooling mode 158. In the first hybrid cooling mode 158, the free cooling system 52 and the vapor compression system 68 (e.g., mechanical cooling system 54) cooperatively operate to satisfy the cooling load demand. However, in some cases, the ambient air temperature may be below the first threshold temperature line 152 at a particular cooling load demand, but the free cooling system 52 and the vapor compression system 68 may not adequately satisfy the cooling load demand (e.g., when the cooling load demand exceeds a cooling load demand threshold line 159 for a particular ambient air temperature). Therefore, the second compressor 91 of the second vapor compression system 90 (e.g., mechanical cooling system 54) may be operated in addition to the air-cooled heat exchanger 56 (e.g., free cooling system 52) and the compressor 70 of the vapor compression system 68 to achieve the desired level of cooling. In such cases, the HVAC&R system 10 may operate in a second hybrid cooling mode 160.

As the ambient air temperature increases above the first threshold temperature line 152 for a particular cooling load demand, the free cooling system 52 may consume energy without providing a correspondingly sufficient amount of cooling to satisfy the particular cooling load demand. In other words, the free cooling system 52 may not operate as efficiently as desired. Therefore, power supplied to the one or more fans 60 may be suspended and/or blocked, and a first mechanical cooling only mode 162 may be implemented. In the first mechanical cooling only mode 162, the controller 78 may operate the compressor 70 of the vapor compression system 68 to cool the cooling fluid 58 flowing through the evaporator 66. The first mechanical cooling only mode 162 may be utilized to achieve the desired level of cooling below a second cooling load demand threshold line 164 for a corresponding ambient air temperature. Thus, when the cooling load demand exceeds the second cooling load demand threshold line 164 and the ambient air temperature exceeds the first threshold temperature line 152, a second mechanical cooling only mode 166 may be initiated by the controller 78. In the second mechanical cooling only mode 166, the controller 78 may operate both the compressor 70 of the vapor compression system 68 and the second compressor 91 of the second vapor compression system 90 in order to satisfy the cooling load demand.

In certain embodiments, the first threshold temperature line 152 and the second threshold temperature line 154 may intersect at a point 168 along an axis 170 representative of the ambient air temperature. The point 168 may be less than a point 172 representative of the temperature of the cooling fluid 58 returning from the load 62, such that heat may be transferred from the cooling fluid 58 to the ambient air.

To improve efficiency (e.g., reduce cycling between different operating modes, reduce power consumption) of the HVAC&R system 10, it may be desirable to transition between the various cooling modes employed by the HVAC&R system 10 (e.g., first and second mechanical cooling modes 162, 166, first and second hybrid cooling modes 158, 160, free-cooling mode 156) to satisfy load demands of the HVAC&R system 10. In some cases, transitioning from one of the available cooling modes to a different cooling mode may enhance the efficiency of the HVAC&R system 10 by reducing the total input power consumed by the HVAC&R system 10 to satisfy a load demand. In other words, while two different operating modes (e.g., different cooling modes) may be utilized to satisfy a load demand, operation of the HVAC&R system 10 in one of the operating modes may consume less power than operation in another of the operating modes. Accordingly, it is desirable to determine (e.g., estimate) power consumption of the HVAC&R system 10 in one or more of the possible (e.g., candidate) operating modes to assess which operating mode may consume less power while still satisfying the load demand.

FIG. 7 illustrates an embodiment of a method 200 (e.g., transition control scheme, control logic) that may be utilized to determine whether operation of the HVAC&R system 10 should transition from one cooling mode to another cooling mode. In particular, the method 200 may be implemented to enable a reduction in power consumption of the HVAC&R system 10 while satisfying a load demand (e.g., cooling load demand, load 62) and thereby increase efficiency of the HVAC&R system 10. For example, the controller 78 (e.g., control system, the processing circuitry 80) may be configured to implement and/or execute the method 200 to control various components of the HVAC&R system 10 (e.g., transition between different cooling modes). That is, computer-executable instructions may be stored on the memory 82, and the processing circuitry 80 may execute the instructions to perform some or all of the steps of the method 200 described below. In other embodiments, the method 200 may be implemented by another controller (e.g., a dedicated controller of the HVAC&R system 10, a vapor compression system controller), more than one controller, or other suitable control system. It should also be noted that additional steps may be performed with respect to the method 200. Moreover, certain steps of the depicted method 20 may be removed, modified, and/or performed in a different order.

As mentioned above, the method 200 may be implemented to determine whether to transition operation of the HVAC&R system 10 from one cooling mode to another cooling mode (e.g., from mechanical cooling mode to hybrid cooling mode, from hybrid cooling mode to free cooling mode, from one hybrid cooling mode to another hybrid cooling mode) to decrease a total amount of energy consumed by the HVAC&R system 10 while still satisfying a cooling load (e.g., load 62), thereby improving efficiency of the HVAC&R system 10. Though the method 200 is illustrated as a series of steps, it should be understood that the method 200 may be executed or implemented as a continual or continuous control loop based on any suitable input, data, or feedback (e.g., feedback from the one or more sensors). That is, the steps of the method 200 may be repeatedly executed (e.g., in a sequential order) to enable evaluation of different candidate cooling modes and determine whether transition from one cooling mode to another cooling mode is desired. Indeed, the method 200 may be continually or continuously executed to dynamically control components of the HVAC&R system 10 in real time (e.g., based on feedback provided by one or more sensors) to satisfy a load demand while limiting or reducing energy consumption (e.g., limiting total power consumed by the HVAC&R system 10 to satisfy the load demand). In some embodiments, one or more steps of the method 200 may be executed or performed simultaneously.

In the illustrated embodiment, the method 200 begins with the HVAC&R system 10 operating in a mechanical cooling mode (e.g., operating the mechanical cooling system 54 alone). While operating in the mechanical cooling mode, the controller 78 may monitor operating conditions (e.g., via one or more sensors) of the HVAC&R system 10 to determine an ambient air temperature and/or a temperature of the cooling fluid 58 entering the evaporator 66 (e.g., chiller entering liquid temperature, temperature of cooling fluid 58 returning from the load 62), such as via feedback received from the return cooling fluid temperature sensor 81. As noted above, in some embodiments, based on the ambient air temperature being relatively low (e.g., 1 to 2 degrees Rankine [R] lower than the temperature of the cooling fluid 58 entering the evaporator 66, 1 to 2 degrees R lower than the temperature of the cooling fluid 58 returning from the load 62, 1 to 2 degrees Fahrenheit [F] lower than the temperature of the cooling fluid 58 entering the evaporator 66, 1 to 2 degrees F. lower than the temperature of the cooling fluid 58 returning from the load 62), the controller 78 may determine that the HVAC&R system 10 may be operated in a hybrid cooling mode to satisfy the load demand of the HVAC&R system 10. In some embodiments, the controller 78 may determine to transition (at block 202) operation of the HVAC&R system 10 to the hybrid cooling mode based on the temperature of the cooling fluid 58 entering the evaporator 66 (e.g., temperature of the cooling fluid 58 returning from the load 62) being below the ambient air temperature (e.g., by a threshold amount).

While operating the HVAC&R system 10 in the hybrid cooling mode, at block 204, the controller 78 may determine a fan speed to operate the free cooling system 52 to satisfy the load demand of the HVAC&R system 10. The controller 78 may determine a suitable or desired fan speed (e.g., speed of fans 60) based on the ambient air temperature and/or the load demand of the HVAC&R system 10. For example, in certain embodiments, the controller 78 may evaluate (e.g., map) gradients of one or more operating parameters, such as total power, cooling capacity, discharge pressure, motor current, or any combination thereof, with respect to one or more of compressor speed, speed of the fans 60 of the air-cooled heat exchanger 56, and/or the speed of the fans 98 of the second air-cooled heat exchanger 97. Additionally, as discussed in greater detail below, if no operating limits are in an active and/or hold state, then a capacity constraint value may be applied to obtain a two-dimensional gradient surface which may be evaluated analytically or by using small increments in each direction on the gradient surface and evaluating the change in total input power.

In certain embodiments, limits may be established or placed (e.g., by the controller 78) on certain operating parameters of the HVAC&R system 10, such as one or more of discharge pressure, motor current, and the like. Each limit may correspond to one of three potential states-inactive, hold, and active. An inactive state may correspond to a state in which the operating parameter does not affect the total input power utilized by the HVAC&R system 10 to satisfy the load 62. A hold state may correspond to a state in which the operating parameter should be maintained at the current value to mitigate variations to the total input power utilized by the HVAC&R system 10 to satisfy the load 62. An active state may correspond to a state in which operation of the HVAC&R system 10 forces a move away from the established limit in a direction defined by the calculated gradient for the corresponding operating parameter. In certain embodiments, if two limits are active for two corresponding operating parameters, then the sum of the two limit gradient vectors may be utilized (e.g., by the controller 78) to determine the direction to adjust the operating parameters to mitigate and/or satisfy the limits. If a single limit is active for a particular operating parameter, then the gradient for the active limit may be projected onto the surface corresponding to the limit in the hold state. Thus, once the effects of all the active and/or hold limits for corresponding operating parameters are considered (e.g., by the controller 78), then the capacity constraint may be applied. As noted above, if no operating limits are in an active and/or hold state for corresponding operating parameters, then applying the capacity constraint may results in a two-dimensional gradient surface. The total power gradient may then be projected onto the fixed capacity surface after the active and/or hold limits are applied, as described in greater detail below.

In some embodiments, the ambient air temperature may change and/or the cooling load demand of the HVAC&R system 10 may change (e.g., increase). For example, based on the ambient air temperature increasing and/or the load demand of the HVAC&R system 10 increasing, at block 206, the controller 78 may determine that operation in the hybrid cooling mode will not adequately satisfy the load demand of the HVAC&R system 10. That is, the controller 78 may determine that operating the free cooling system 52 at an upper capacity limit (e.g., fans 60 associated with the air-cooled heat exchanger 56 operating at an upper speed limit) does not provide sufficient cooling to satisfy the load demand of the HVAC&R system 10. Accordingly, at block 206, the controller 78 may determine to transition operation back to the mechanical cooling mode (e.g., operating of the mechanical cooling system 54 alone) to satisfy the load demand of the HVAC&R system 10, and operation of the free cooling system 52 may be suspended.

While operating the HVAC&R system 10 in the hybrid cooling mode, the controller 78 may determine that operation of the free cooling system 52 alone is capable of satisfying the load demand of the HVAC&R system 10. For example, the controller 78 may estimate the free cooling capacity of the free cooling system 52 and may estimate the fan power (e.g., power consumption) of the fans 60 to determine if operation of the free cooling system 52 alone results in a lower total input power (e.g., lower power consumption by the HVAC&R system 10). Accordingly, the controller 78 may proceed with the method 200 to evaluate whether operation of the HVAC&R system 10 should transition from the hybrid cooling mode to a free cooling mode (e.g., operation of the free cooling system 52 alone). To this end, the controller 78 may be configured to estimate and/or determine power consumption (e.g., total input power) of the HVAC&R system 10 in the hybrid cooling mode and the free cooling mode to assess which operating mode is more efficient. For example, at block 208, the controller 78 estimates a condenser effectiveness of the condenser 72 of the HVAC&R system 10 in the hybrid cooling mode utilizing various design operating parameters of the HVAC&R system 10 and/or data received from the one or more sensors. That is, the controller 78 may determine and/or estimate condenser effectiveness of the condenser 72 based one or more of the following parameters: an operating speed of the fans 60, an operating speed of the fans 98, a design altitude (e.g., predetermined value), a design ambient air temperature (e.g., predetermined value), a design fan power input (e.g., predetermined value), a design air flow rate (e.g., predetermined value), a design cooling capacity (e.g., predetermined value), a design compressor input power (e.g., predetermined value), a design discharge saturation pressure (e.g., predetermined value), or any combination thereof to estimate the condenser effectiveness. Further, at block 208, the controller 78 may calculate the air mass flow rate of the ambient air flow directed across the air-cooled heat exchanger 56 (e.g., via fans 60) and/or the second air-cooled heat exchanger 97 (e.g., via fans 98) utilizing design operating data (e.g., predetermined values) and/or data received from the one or more sensors. In some embodiments, the condenser effectiveness may be a function of the air flow rate of ambient air across the air-cooled heat exchanger 56, the second air-cooled heat exchanger 97, the condenser coil 72, and/or the condenser coil 92. In some embodiments, a coefficient may be applied based on the air flow rate of the ambient air flow directed across the air-cooled heat exchanger 56 (e.g., speed of the fans 60) and/or the second air-cooled heat exchanger 97 (e.g., speed of the fans 98).

At block 210, the controller 78 may estimate the condenser 72 heat rejection (e.g., amount of heat rejection, heat rejection rate) of the HVAC&R system 10 based on data received from the one or more sensors and/or design performance operating data (e.g., predetermined values). For example, the controller 78 may utilize data including one or more of the following: ambient air temperature (e.g., operating ambient air temperature, design ambient air temperature), saturated discharge temperature, saturated suction temperature, temperature of cooling fluid 58 entering the air-cooled heat exchanger 56, temperature of cooling fluid 58 leaving the air-cooled heat exchanger 56, temperature of the cooling fluid 58 entering the second air-cooled heat exchanger 97, temperature of the cooling fluid 58 leaving the second air-cooled heat exchanger 97, temperature of cooling fluid 58 leaving the evaporator 66, design cooling capacity of the free cooling system 52, design cooling capacity of the mechanical cooling system 54, total design cooling capacity of the HVAC&R system 10, design compressor 70 input power, or any combination thereof to estimate the condenser 72 heat rejection of the HVAC&R system 10. It should be noted that, in estimating the condenser 72 heat rejection of a particular operating mode of the HVAC&R system 10, the controller 78 may be configured to assume steady state and/or constant values for one or more calculations performed by the controller 78. In some embodiments, the controller 78 may be configured to monitor operating parameters and assume the HVAC&R system 10 is operating in a steady state based on operating conditions indicating that certain detected values (e.g., for a particular operating parameter) deviate from one another by less than a threshold amount. For example, the controller 78 may be configured to monitor an input power applied to the HVAC&R system 10, and upon determining that a first input power at a first recorded time deviates from a second input power at a second recorded time by less than a threshold amount (e.g., less than 5%), the controller 78 may assume the HVAC&R system 10 is operating in a steady state, such that the calculations disclosed herein may be performed in a desired manner.

At block 212, the controller 78 may determine a ratio of cooling capacity provided by each of the cooling systems (e.g., mechanical cooling system 54, free cooling system 52) to satisfy the cooling demand of the HVAC&R system 10 in the hybrid cooling mode. For example, the controller 78 may utilize data received from the sensors indicative of a temperature of the cooling fluid 58 entering the air-cooled heat exchanger 56, a temperature of the cooling fluid 58 leaving the air-cooled heat exchanger 56, and a temperature of the cooling fluid 58 leaving the evaporator 66 to determine the ratio of cooling capacity provided by the free cooling system 52 and cooling capacity provided by the mechanical cooling system 54.

Upon determining the ratio of free cooling capacity to mechanical cooling capacity provided by the HVAC&R system 10, at block 214, the controller 78 may determine an amount of cooling capacity provided by each of the cooling systems (e.g., free cooling system 52, mechanical cooling system 54, total amount of cooling capacity provided by both the free cooling system 52 and the mechanical cooling system 54) employed by the HVAC&R system 10 to meet the load demand of the HVAC&R system 10. The controller 78 may determine the cooling capacity provided by each of the cooling systems employed by the HVAC&R system 10 to satisfy the load demand based on certain of the calculations performed in the method 200 discussed above, data from the one or more sensors indicative of the operating conditions of the HVAC&R system 10, and/or previous data associated with operation of the HVAC&R system 10 (e.g., historical data, design data). For example, utilizing data received from the sensors indicative of saturated discharge temperature, ambient air temperature, and/or compressor 70 input power, the estimated condenser effectiveness determined in block 208, the air mass flow rate of the ambient air flow directed across the air-cooled heat exchanger 56 determined in block 208, the condenser 72 heat rejection determined in block 210, and/or the ratio of free cooling capacity to mechanical cooling capacity determined in block 212, the controller 78 may estimate the cooling capacity provided by the mechanical cooling system 54. In turn, utilizing the ratio of free cooling capacity to mechanical cooling capacity, the controller 78 may estimate the amount of cooling capacity provided by the free cooling system 52. The controller 78 may determine a total amount of cooling capacity provided by the HVAC&R system 10 based on a sum of the amount of mechanical cooling capacity with the amount of free cooling capacity.

Upon estimating the total amount of cooling capacity provided by the HVAC&R system 10 in the hybrid cooling mode, the controller 78 may, at block 216, determine whether a different cooling mode (e.g., operation of the free cooling system 52 alone) is capable of achieving the total cooling capacity determined in block 214. For example, the controller 78 may estimate a total amount of cooling capacity provided by operating the free cooling system 52 at an upper capacity limit (e.g., fans 60 associated with air-cooled heat exchanger 56 operating at an upper speed limit) under certain operating conditions (e.g., a particular ambient air temperature). In some embodiments, utilizing design data and/or data received from the one or more sensors indicative of suction and/or discharge temperature and/or pressure measurements, design fan 60 power, density of ambient air at the condenser 72, compressor 70 input power, ambient air temperature, the ratio determined at block 212, and/or other suitable parameters, the controller 78 may determine whether operation in the free cooling only mode is capable of achieving the total cooling capacity demanded of the HVAC&R system 10. In some embodiments, at block 216, the controller 78 may be configured to adjust calculations based on cooling fluid 58 side resistance (e.g., thermal resistance) and/or air side resistance (e.g., thermal resistance) in determining whether operation in the free cooling only mode is capable of satisfying the load demand of the HVAC&R system 10.

Upon a determination that operation of the free cooling system 52 alone will not adequately provide the total amount of cooling capacity demanded of the HVAC&R system 10, the controller 78 may continue operating the HVAC&R system 10 in the current (e.g., hybrid cooling) operating mode. Upon a determination that operation of the free cooling system 52 alone is capable of adequately providing the total amount of cooling capacity demanded of the HVAC&R system 10, then the method 200 may proceed to block 218. At block 218, the controller 78 may determine an estimated input power consumed by the HVAC&R system 10 in the free cooling only mode to achieve and/or provide the total demanded cooling capacity.

In some embodiments, the controller 78 may, at block 218, estimate or determine corresponding amounts of input power (e.g., power consumed by fans 60), speeds of the fans 60, ambient air temperature, ambient air density (e.g., at the condenser 72), and/or condensing temperatures associated with each of multiple cooling capacities of the free cooling system 52. For example, the controller 78 may iteratively calculate various free cooling capacities provided by the free cooling system 52 and the corresponding input power consumed (e.g., by fans 60 and/or fans 98 of the free cooling system 52) to achieve the free cooling capacities based on different fan speeds used by the free cooling system 52 and/or the ambient air temperature. As will be appreciated, different fan speeds may be associated with different amounts of input power consumed and may also be associated with different cooling capacities based on ambient air temperature and the air mass flow rate of the ambient air flow directed through the free cooling system 52 (e.g., ambient air flow directed across the air-cooled heat exchanger 56 via the fans 60, ambient air flow directed across the second air-cooled heat exchanger 97 via the fans 98, etc.). At block 218, the controller 78 may determine which candidate fan speed(s) may be utilized to achieve the total cooling capacity determined in block 214 along with the corresponding input power consumed (e.g., by the fans 60) to operate the free cooling system 52 at the particular fan speed(s). That is, the controller 78 may generate one or more input power estimates and each of the input power estimates may correspond to a different fan speed capable of satisfying the load demand of the HVAC&R system 10.

At block 220, the controller 78 may compare the different input powers associated with the different fan speeds (e.g., of the fans 60 and/or the fans 98) capable of satisfying the total cooling capacity of the HVAC&R system 10 (e.g., in the free cooling mode) to the total input power consumed by the HVAC&R system 10 in the hybrid cooling mode, which may be derived from the one or more sensors. At block 222, the controller 78 may determine to transition from the hybrid cooling mode to the free cooling mode based on the comparison performed in block 220. For example, upon determining that a corresponding total input power associated with a fan speed of the fans 60 capable of satisfying the total cooling capacity of the HVAC&R system 10 in the free cooling mode is less than the total input power consumed by the HVAC&R system 10 (e.g., by the fans 60 and the compressor 70) in the hybrid cooling mode, the controller 78 may determine to transition operation of the HVAC&R system 10 to the free cooling mode. In some embodiments, the controller 78 may be configured to apply a deadband factor before determining whether to transition to the free cooling operating mode. For example, the controller 78 may apply a deadband (e.g., additional) value, amount, and/or range associated with cooling capacity (e.g., increased cooling capacity, 10 tons), input power consumed, amount of input power over time, total input power percentage, efficiency metric, and/or other suitable parameter. In this way, the method 200 may enable a reduction in cycling (e.g., cycling between different operating modes, on/off cycling of the fans 60 and/or compressor 70) performed by the HVAC&R system 10, as well as ensure that the load demand of the HVAC&R system 10 will be satisfied via operation in the free cooling mode. For example, in some embodiments, upon a determination by the controller 78 that the free cooling mode is capable of providing the total cooling capacity determined in block 214 but is not capable of also providing an additional 10 tons of cooling capacity (e.g., deadband value of cooling capacity), then the controller 78 may determine that operation of the HVAC&R system 10 should not transition to the free cooling mode.

With the HVAC&R system operating in the free cooling mode, at block 224, the controller 78 may determine that the free cooling system 52 is not capable of satisfying the load demand (e.g., load 62) of the HVAC&R system 10. For example, based on the ambient air temperature increasing and/or the load demand 62 of the HVAC&R system 10 increasing, the free cooling system 52 may no longer operate to adequately provide the total cooling capacity demanded of the HVAC&R system 10 while operating the fans 60 and/or fans 98 of the free cooling system 52 (e.g., at an upper capacity limit). For example, the controller 78 may estimate the HVAC&R system 10 input power at a desired or determined speed of the fans 60 in the hybrid cooling mode and compare the estimated input power value in the hybrid cooling mode to an input power value associated with operating the fans 60 at an upper capacity limit in the free cooling mode for a particular (e.g., current) set of operating conditions (e.g., ambient temperature and cooling load). The controller 78 may determine that the estimated input power value in the hybrid cooling mode is less than the input power value corresponding to operating the fans 60 in the free cooling mode at an upper capacity limit. Accordingly, at block 224, the controller 78 may determine to transition back to the hybrid cooling mode, whereby the mechanical cooling system 54 may provide a portion of the total cooling capacity to satisfy the load demand of the HVAC&R system 10. In some embodiments, the transition from free cooling mode to hybrid cooling mode and/or the transition from hybrid cooling mode to mechanical cooling mode may be based on a determination that a temperature difference between the temperature of the cooling fluid 58 entering the air-cooled heat exchanger 56 and the ambient air temperature drops below a threshold difference value.

In certain embodiments, visual models may facilitate understanding of the optimization process described above that enables transitioning between various available cooling modes. For example, total input power of the HVAC&R system 10 may be represented with a surface. The slope of the surface may correspond to a gradient of total input power. The gradient may be a vector that points in the direction of the steepest slope of the surface. A positive gradient value may indicate that total input power increases as the speed of the fans 60 increase, and thus lower speeds associated with the fans 60 correspond to greater relative efficiencies. Similarly, a negative gradient may indicate that a higher speed of the fans 60 may result in greater efficiency. In embodiments in which no active constraints are present, improved or desired efficiency may occur at a zero gradient. Thus, for a given surface representative of total input power of the HVAC&R system 10, the gradients may be evaluated, thereby enabling incremental adjustment of fan speeds to reduce total energy use (e.g., reduce power consumption). The output of the evaluation may correspond to a new discharge pressure set point (e.g., adjustment in operation of the compressor 70) and/or a direct change in a speed of the fans 60, in some embodiments.

In embodiments in which active constraints are present, fan speeds may be limited by discharge pressure or oil pressure, and the fan speed of one system (e.g., vapor compression system, free cooling system) may have an effect on the discharge pressure of another system (e.g., vapor compression system). For example, in an embodiment where a first system (e.g., vapor compression system) has an active discharge pressure limit and a second system (e.g., vapor compression system) does not have an active discharge pressure limit, increasing the fan speed for the second system would increase the free cooling capacity, which may reduce the capacity demanded from the respective compressors of the two systems. The lower relative compressor capacity may reduce the discharge pressure for the first system even without changing the fan speed for that system. Existing controls may not account for this interaction and instead may rely on feedback indicative of the temperature of the cooling fluid 58 leaving the evaporator 66 and/or the discharge pressure of the cooling fluid 58 leaving the evaporator 66. For example, an estimated desired fan speed of the fans 60 may be calculated and pressure limits may override implementation of the fan speed. Thus, using the example above, an increase in the fan speed for the second system will increase the cooling capacity. After a delay (e.g., 1 second, 2 seconds, 5 seconds, or more) the colder cooling fluid from the free cooling heat exchanger will result in a reduced leaving evaporator liquid temperature. The HVAC&R system 10 capacity controls may respond by reducing the compressor speed, thereby resulting in a lower discharge pressure for both systems. The controls may then reduce the fan speed for the first system to restore the discharge pressure to an acceptable value. Thus, an increase in fan speed for one system can force a reduction in fan speed for the other system, and if this interaction is ignored, then the estimated final operating point may deviate from the desired operating conditions. Additionally, the time delays involved in the interactions may create or amplify stability problems.

To address the shortcomings discussed above, Equation (1) below may be utilized to illustrate an interaction between a gradient, G, and a constraint. The constraint is represented as a surface with a unit normal vector, n, and θ is the angle between G and n. The Vector P is the gradient G projected onto the constraint surface, and is determined using Equation (1) below.

$$P = G - n ( n \cdot G ) \qquad ( 1 )$$

Equation 1 may be valid for cases where n G is positive. A negative value of this dot product indicates that the gradient would move away from the constraint condition so the constraint is no longer active. In certain embodiments, additional equations may be utilized in accordance with the present techniques. For example, Equation (2) may be utilized to estimate the cooling capacity (i.e., TR_{evap,est}) of a particular embodiment of the HVAC&R system 10, using the VSD 71 frequency (i.e., HZ_{cmpr}) of the compressor 70, the limiting value of the discharge pressure (i.e., P_{disch,lim}) of the working fluid 76, the suction pressure (i.e., P_{suct}) of the working fluid 76, the average barometric pressure at a given altitude (i.e., P_{avg,alt}), the saturated suction temperature (i.e., STP) of working fluid 76 in the evaporator 66, and the condenser 72 leaving liquid temperature (T_{liq}) (e.g., temperature of the working fluid 76 leaving the condenser 72).

$$T {R}_{evap , est} = {C}_{TR} \cdot [ {Hz}_{cmpr} - {C}_{0 , Hz} - {C}_{1 , Hz} \cdot \frac{( {P}_{disch , lim} + {P}_{avg , alt} )}{( {P}_{suct} + {P}_{avg , alt} )} ] \cdot [ {C}_{0 , TR} + {C}_{1 , TR} \cdot ( {T}_{liq} - STP ) ] \qquad ( 2 )$$

In certain embodiments, each of the C_{TR}, C_{0,Hz}, C_{1,Hz} values may be constants that are derived based on the operating parameters of the cooling fluid 58 directed through the HVAC&R system 10. Additionally, the constants C_{TR}, C_{0,Hz}, C_{1,Hz} may be dependent on other operating parameters associated with the working fluid 76 directed through the HVAC&R system 10. For example, the C_{0,TR} Value may be determined using Equation (3) below, where B_{0,TR}, B_{1,TR}, and B_{2,TR} are constants that are derived based on the particular working fluid 76 directed through the HVAC&R system 10.

$${C}_{0 , TR} ≡ {B}_{0 , TR} + {B}_{1 , TR} \cdot STP + {B}_{2 , TR} \cdot {STP}^{2} \qquad ( 3 )$$

Similarly, the C_{1,TR} value may be determined using Equation (4) below, where M_{0,TR}, M_{1,TR}, M_{2,TR}, and M_{3,TR} are constants that are also derived based on the particular working fluid 76 directed through the HVAC&R system 10.

$${C}_{1 , TR} ≡ {M}_{0 , TR} + {M}_{1 , TR} \cdot STP + {M}_{2 , TR} \cdot {STP}^{2} + {M}_{3 , TR} \cdot {STP}^{3} \qquad ( 4 )$$

In certain embodiments, the average barometric pressure at a given altitude (i.e., P_{avg,alt}) may be determined using Equation (5) below, based on the installed altitude (i.e., Alt) of the HVAC&R system 10.

$${P}_{avg , alt} = 14.696 \cdot {[ 1 - ( 6.8754 E - 6 ) \cdot Alt ]}^{5.2559} \qquad ( 5 )$$

Additionally, in certain embodiments, an estimate of the coefficient of performance of the compressor 70 associated with a particular limiting value of discharge pressure (i.e, COP_{cmpr,lim}) of the working fluid 76 may be calculated using Equation (6) below, where B_{COP} and M_{COP} are constants derived based on the cooling fluid 58 directed through the HVAC&R system 10.

$${COP}_{cmpr , lim} = {B}_{COP} + {M}_{COP} \cdot \frac{( {P}_{disch , lim} + {P}_{avg , alt} )}{( {P}_{suct} + {P}_{avg , alt} )} \qquad ( 6 )$$

Further, Equation (7) below may be utilized to calculate an estimate of total heat rejection across coils of the condenser 72 at a particular limiting value of discharge pressure (i.e., THRₗᵢₘ) of the working fluid 76 using the estimate of coefficient of performance (i.e., COP_{cmpr,lim}) determined by Equation (6) above and the estimate of the HVAC&R system 10 cooling capacity (i.e., TR_{evap,est}) determined by Equation (2) above.

$${THR}_{lim} = {TR}_{evap , est} \cdot ( 1 + {COP}_{cmpr , lim} ) \qquad ( 7 )$$

In certain embodiments, Equation (8) below may be utilized to calculate an estimate of saturated discharge temperature of the working fluid 76 at a particular limiting value of discharge pressure (i.e., DTP lim) based on the limiting value of discharge pressure (i.e., P_{disch,lim}) and constant values C_{0,Pdisch}, C_{1,Pdisch}, and C_{2,Pdisch} derived based on the working fluid 76 directed through the HVAC&R system 10.

$${DTP}_{lim} = {( \frac{{P}_{disch , lim} - {C}_{0 , {P}_{disch}}}{{C}_{1 , {P}_{disch}}} )}^{0.25} - {C}_{2 , {P}_{disch}} \qquad ( 8 )$$

Furthermore, based on the values derived from the equations above, an estimated speed of the fans 60 at a particular limiting value of discharge pressure (i.e., Hz_{fans,lim}) may be determined utilizing Equation (9) below, where C_{0,UA} and C_{1,UA} are constants derived based on the frequency applied to the fans 60 of the HVAC&R system 10 and the T_{amb} is a temperature value associated with the ambient air surrounding the HVAC&R system 10. For example, the estimate of saturated discharge temperature at a particular limiting value of discharge pressure (i.e., DTPₗᵢₘ) may be obtained from Equation (8) above and the estimate of total heat rejection across coils of the condenser 72 at a particular limiting value of discharge pressure (i.e., THRₗᵢₘ) may be obtained from Equation (7) above. Thus, using the above-described values, Equation (9) may be employed to determine the estimated speed of the fans 60 at the particular limiting value of discharge pressure (i.e., Hz_{fans,lim}).

$${Hz}_{fans , lim} = ( \frac{1}{{C}_{1 , UA}} ) \cdot [ \frac{12000 \cdot {THR}_{lim}}{( {DTP}_{lim} - {T}_{amb} )} - {C}_{0 , UA} ] \qquad ( 9 )$$

The present disclosure may provide one or more technical effects useful in the operation of an HVAC&R system. For example, the HVAC&R system may include a mechanical cooling system and a free cooling system and thus may be capable of operating in various cooling modes (e.g., mechanical cooling mode only, free cooling mode only, hybrid cooling mode) to satisfy a load demand of the HVAC&R system while increasing efficiency. The HVAC&R system may utilize various methods to control operation of the HVAC&R system including methods to control transition between available cooling modes to satisfy a cooling load while limiting an amount of energy consumption by the HVAC&R system. By monitoring the operating conditions of the HVAC&R system (e.g., via one or more sensors) and/or utilizing design and/or historical data, a total amount of cooling capacity provided by the cooling mode in which the HVAC&R system is operating may be determined by a controller. The controller may also determine whether a different cooling mode is capable of satisfying the total cooling capacity provided by the current cooling mode of the HVAC&R system. If the different cooling mode is capable of providing the total cooling capacity demanded of the HVAC&R system, a corresponding total input power for the different cooling mode may be determined, thereby enabling a comparison of total input powers for the current cooling mode and the different cooling mode of the HVAC&R system. In this way, the controller may select a cooling mode with a reduced total input power that is still capable of satisfying the load demand of the HVAC&R system. Thus, the techniques discussed herein enable more efficient operation of the HVAC&R system at reduced costs (e.g., reduced energy input). The technical effects and technical problems in the specification are examples and are not limiting. It should be noted that the embodiments described in the specification may have other technical effects and can solve other problems.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heating, ventilation, air conditioning, and refrigeration (HVAC&R) system configured to operate in a plurality of cooling modes, comprising:
a mechanical cooling system configured to place a working fluid in a heat exchange relationship with a cooling fluid;
a free cooling system configured to place the cooling fluid in a second heat exchange relationship with an ambient air flow; and
a controller comprising processing circuitry and a memory, wherein the memory comprises instructions that, when executed by the processing circuitry, are configured to cause the processing circuitry to transition operation of the HVAC&R system between the plurality of cooling modes based on a cooling demand of the HVAC&R system and based on an estimated power consumption of the HVAC&R system.

2. The HVAC&R system of claim 1, wherein the instructions, when executed by the processing circuitry, are configured to cause the processing circuitry to:
operate the mechanical cooling system and suspend operation of the free cooling system in a mechanical cooling mode of the plurality of cooling modes;
operate the free cooling system and suspend operation of the mechanical cooling system in a free cooling mode of the plurality of cooling modes; and
operate the mechanical cooling system and operate the free cooling system in a hybrid cooling mode of the plurality of cooling modes.

3. The HVAC&R system of claim 2, wherein the instructions, when executed by the processing circuitry, are configured to cause the processing circuitry to transition operation of the HVAC&R system from the mechanical cooling mode to the hybrid cooling mode based on a determination that an ambient air temperature is less than a temperature of the cooling fluid received by the HVAC&R system.

4. The HVAC&R system of claim 2, wherein the instructions, when executed by the processing circuitry, are configured to cause the processing circuitry to:
transition operation of the HVAC&R system from the hybrid cooling mode to the free cooling mode based on a first determination that operation of the HVAC&R system in the free cooling mode is expected to satisfy the cooling demand and based on a second determination that a first estimated power consumption of the HVAC&R system in the free cooling mode is less than a second estimated power consumption of the HVAC&R system in the hybrid cooling mode.

5. The HVAC&R system of claim 4, wherein the free cooling system comprises a heat exchanger configured to direct the cooling fluid therethrough and a fan configured to force the ambient air flow across the heat exchanger, and wherein the instructions, when executed by the processing circuitry, are configured to cause the processing circuitry to estimate a power consumption of the fan to determine the first estimated power consumption, the second estimated power consumption, or both.

6. The HVAC&R system of claim 5, wherein the mechanical cooling system comprises a compressor configured to direct the working fluid through the mechanical cooling system, and wherein the instructions, when executed by the processing circuitry, are configured to cause the processing circuitry to estimate a power consumption of the compressor to determine the second estimated power consumption.

7. The HVAC&R system of claim 6, wherein the mechanical cooling system comprises a condenser configured to place the working fluid in a third heat exchange relationship with the ambient air flow, and wherein the instructions, when executed by the processing circuitry, are configured to cause the processing circuitry to estimate an effectiveness of the condenser to determine the second estimated power consumption.

8. The HVAC&R system of claim 4, wherein the instructions, when executed by the processing circuitry, are configured to cause the processing circuitry to:
transition operation of the HVAC&R system from the free cooling mode to the hybrid cooling mode based on a third determination that the second estimated power consumption of the HVAC&R system in the hybrid cooling mode is less than the first estimated power consumption of the HVAC&R system in the free cooling mode.

9. The HVAC&R system of claim 4, wherein the instructions, when executed by the processing circuitry, are configured to cause the processing circuitry to:
transition operation of the HVAC&R system from the free cooling mode to the hybrid cooling mode based on a third determination that operation of the HVAC&R system in the free cooling mode is not expected to satisfy the cooling demand.

10. A tangible, non-transitory, computer-readable medium, comprising instructions executable by processing circuitry of a heating, ventilation, air conditioning, and refrigeration (HVAC&R) system that, when executed by the processing circuitry, cause the processing circuitry to:
operate a mechanical cooling system and a free cooling system in a hybrid cooling mode of the HVAC&R system;
calculate an estimated total amount of cooling capacity provided by the HVAC&R system in the hybrid cooling mode;
calculate a first estimated amount of input power consumed by the mechanical cooling system and the free cooling system in the hybrid cooling mode to provide the estimated total amount of cooling capacity;
determine that operation of the free cooling system and suspended operation of the mechanical cooling system in a free cooling mode of the HVAC&R system is expected to provide the estimated total amount of cooling capacity;
calculate a second estimated amount of input power consumed by the free cooling system in the free cooling mode to provide the estimated total amount of cooling capacity;
compare the first estimated amount of input power to the second estimated amount of input power; and
transition operation of the HVAC&R system from the hybrid cooling mode to the free cooling mode in response to a determination that the second estimated amount of input power is less than the first estimated amount of input power.

11. The computer-readable medium of claim 10, wherein the instructions, when executed by the processing circuitry, cause the processing circuitry to:
calculate an effectiveness of a condenser of the mechanical cooling system based on an operating speed of a fan of the mechanical cooling system, an ambient air temperature, an estimated mass flow rate of ambient air directed across the condenser, a first power input of the fan, a second power input of a compressor of the mechanical cooling system, or a combination thereof; and
calculate the estimated total amount of cooling capacity based on the effectiveness of the condenser.

12. The computer-readable medium of claim 10, wherein the instructions, when executed by the processing circuitry, cause the processing circuitry to calculate an estimated input power of a fan of the free cooling system based on the second estimated amount of input power consumed by the free cooling system in the free cooling mode.

13. The computer-readable medium of claim 10, wherein the instructions, when executed by the processing circuitry, cause the processing circuitry to determine a ratio of a first amount of the estimated total amount of cooling capacity provided by the mechanical cooling system and a second amount of the estimated total amount of cooling capacity provided by the free cooling system.

14. The computer-readable medium of claim 10, wherein the instructions, when executed by the processing circuitry, cause the processing circuitry to transition operation of the HVAC&R system from the free cooling mode to the hybrid cooling mode in response to an additional determination that the first estimated amount of input power is less than the second estimated amount of input power.

15. The computer-readable medium of claim 10, wherein the instructions, when executed by the processing circuitry, cause the processing circuitry to operate the mechanical cooling system and suspend operation of the free cooling system in a mechanical cooling mode of the HVAC&R system based on an additional determination that an ambient air temperature is greater than a temperature of a cooling fluid received by the HVAC&R system.

16. The computer-readable medium of claim 10, wherein the instructions, when executed by the processing circuitry, cause the processing circuitry to adjust operation of a compressor of the mechanical cooling system and adjust operation of a fan of the free cooling system in the hybrid cooling mode to reduce power consumption of the HVAC&R system.

17. The computer-readable medium of claim 10, wherein the instructions, when executed by the processing circuitry, cause the processing circuitry to transition operation of the HVAC&R system from the hybrid cooling mode to the free cooling mode in response to an additional determination that operation of the HVAC&R system in the free cooling mode is expected to provide a cooling capacity greater than the estimated total amount of cooling capacity.

18. A heating, ventilation, air conditioning, and refrigeration (HVAC&R) system, comprising:
a mechanical cooling system configured to circulate a working fluid therethrough and to transfer heat from a cooling fluid to the working fluid;
a free cooling system configured circulate the cooling fluid therethrough and to transfer heat from the cooling fluid to ambient air; and
a controller configured to:
operate the mechanical cooling system and suspend operation of the free cooling system in a mechanical cooling mode of the HVAC&R system;
operate the free cooling system and suspend operation of the mechanical cooling system in a free cooling mode of the HVAC&R system;
operate the mechanical cooling system and operate the free cooling system in a hybrid cooling mode of the HVAC&R system; and
transition operation of the HVAC&R system between the mechanical cooling mode, the free cooling mode, and the hybrid cooling mode based on a cooling demand of the HVAC&R system, a first power consumption associated with operation of the mechanical cooling system, and a second power consumption associated with operation of the free cooling system.

19. The HVAC&R system of claim 18, wherein the controller is configured to:
transition operation of the HVAC&R system from the mechanical cooling mode to the hybrid cooling mode based on a first determination that an ambient air temperature is less than a temperature of the cooling fluid received by the HVAC&R system; and
transition operation of the HVAC&R system from the hybrid cooling mode to the free cooling mode based on a second determination that operation of the HVAC&R system in the free cooling mode is expected to provide a first cooling capacity in the free cooling mode equal to or greater than a second cooling capacity of the HVAC&R system in the hybrid cooling mode and based on a third determination that a first estimated power consumption of the HVAC&R system in the free cooling mode is less than a second estimated power consumption of the HVAC&R system in the hybrid cooling mode.

20. The HVAC&R system of claim 19, wherein the first estimated power consumption comprises power input of a fan of the free cooling system, and the second estimated power consumption comprises power input of a compressor of the mechanical cooling system and power input of the fan of the free cooling system.
